(19) United States
(12) Patent Application Publication
(10) Pub. No.: US 2009/0280304 A1
(43) Pub. Date: Nov. 12, 2009

(54) Method for defining regions of differing porosity of a nitrocellulose film on a substrate

(76) Inventors: Ko-Yuan Tseng, Hsinchu (TW); Shaw-Tzu Wang, Taipei (TW); James Russell Webster, Hsinchu (TW)

Correspondence Address: AGNEW INTERNATIONAL;PATENT & TRADEMARK LAW FIRM, 7700 Irvine Center Drive, SUITE 800, Irvine, CA, 92618, US

(21) Appl. No.: 12/437,520

(22) Filed: May 7, 2009

Related U.S. Application Data
(60) Provisional application No. 61/051,011, filed on May 7, 2008.
(60) Provisional application No. 61/073,763, filed on Jun. 19, 2008.

(51) Int. Cl. B32B 5/18; B44C 1/22; C23F 1/08

(52) U.S. Cl. 428/195.1; 216/58; 156/345.26

(57) ABSTRACT

A method of forming a pattern on a nitrocellulose film on a substrate by providing a nitrocellulose based film of uniform porosity on a substrate; defining a desired pattern on said substrate wherein at least one region of lower porosity is defined and wherein at least one region of normal porosity is defined; exposing to a flow of a suitable solvent vapor over said region of lower porosity wherein said nitrocellulose based film of said region of lower porosity is dissolved by said suitable solvent vapor; removing said suitable solvent vapor and said nitrocellulose based film from said region of lower porosity wherein said lower porosity is capable of separating multiple experiments that are performed simultaneously over said region of normal porosity.

### CROSS REFERENCE TO RELATED APPLICATION

This application claims the benefit of priority under 35 U.S.C. 119(e) to the filing date of U.S. provisional patent application No. 61/051,011 entitled “Method for defining regions of differing porosity of a nitrocellulose film on a substrate” which was filed on May 7, 2008, and U.S. provisional patent application No. 61/073,763 entitled “Method for defining regions of differing porosity of a nitrocellulose film on a substrate” which was filed on Jun. 19, 2008 and are incorporated herein by reference.

### FIELD OF THE INVENTION

The present invention relates generally to methods for defining regions of differing porosity of a nitrocellulose film on a substrate. Specifically, the present invention is related to forming patterns on nitrocellulose slides using a suitable solvent vapor to define a lower porosity region as oppose to high porosity region for the purpose of defining regions of differing porosity of a nitrocellulose film on a substrate. More specifically, the present invention is related to forming patterns on nitrocellulose slides using a suitable solvent vapor to define a lower porosity region as oppose to a high porosity region for purpose of defining regions of differing porosity of a nitrocellulose film on a substrate using an XZY robot and flat hypodermic needle.

### BACKGROUND OF THE INVENTION

Nitrocellulose is a common material used for binding of proteins for biochemical assays such as antibody/antigen reactions. Nitrocellulose membranes currently are the main support matrix for “rapid test” products such as over the counter urine tests (U.S. Pat. No. 6,818,455 & U.S. Pat. No. 5,602,040) as well as a variety of blood tests. Theses rapid test products are readily usable by an unskilled person and which preferably merely requires that some portion of the product is contacted with the sample (e.g. a urine stream in the case of a pregnancy or ovulation test) and thereafter no further actions are required by the user before an analytical result can be observed. Typically, the analytical result should be observable within a matter of minutes following sample application, e.g. ten minutes or less.

The high protein binding capacity and reliable “wicking” ability of the membranes has secured their use in the market for many years. With the advent of microarray techniques there has been interest in providing nitrocellulose films on glass slide substrates [1,2]. Most commonly such films have a high degree of porosity, are typically white, and are usually provided as defined regions on a glass slide. Since the films are porous, defined regions are necessary to perform multiple experiments on 1 slide without cross-contamination. Examples of such slides are available from GE Healthcare (Whatman FAST Slides), Grace Bio Labs (ONCYTE Slides) and more recently by Schott. In most cases the nitrocellulose film is applied to the glass using a spin casting method. Following casting of the porous film, the nitrocellulose is removed in unwanted areas to define regions or “pads”. Alternatively a transparent nitrocellulose film (U.S. Pat. No. 6,861,251) is available from GenTel Biosciences (PATH Slides). This is a non-porous film and therefore defined regions are not necessary. In most cases slides are mounted in a frame that facilitates the processing of multiple assays at one time such as in U.S. Pat. No. 7,063,979.

Although the technology has been fairly mature as to casting porous films, the removal process of nitrocellulose in unwanted areas to define regions or “pads” needs vast improvements. Specifically, it is unresolved that an effective, fast, efficient and economical method to remove nitrocellulose in unwanted area to define region of pads is needed to reduce the costs of preparing nitrocellulose film on a substrate wherein such substrate is capable of performing multiple immunoassay experiments.

### REFERENCES

1. Cytometrically coherent transfer of receptor proteins on microporous membrane. BioTechniques Vol. 11, No 3: 352-361, 1991.
2. High Definition cell analysis in situ using microporous films. Cell Vision, vol. 2, No 6: 499-590, 1995.

### OBJECT OF THE INVENTION

It is an object of this invention to provide a method to effectively and efficiently define regions of differing porosity of a nitrocellulose film on a substrate.

It is an object of this invention to provide a method to effectively and efficiently pattern nitrocellulose slide on a substrate.

It is a further an object of this invention to provide a method of pattern nitrocellulose slide in a cost effective manner.

It is further an object of this invention to provide an apparatus to pattern nitrocellulose slide in a cost effective manner

It is further an object of this invention to provide an apparatus that efficiently defines regions of differing porosity of a nitrocellulose film on a substrate.

### SUMMARY OF THE INVENTION

The present invention relates to the production of defined regions of differing porosity of a nitrocellulose(NC)-based film on a substrate. Starting with a substrate which has a nitrocellulose-based film of uniform porosity, areas of the film are exposed to a flow of a suitable solvent vapor such that the film in the exposed area is dissolved in the solvent vapor and upon removal of the solvent vapor will dry as a film of lower porosity than the original film. The lower porosity region is then sufficient to separate (usually using a frame with a rubber seal) multiple experiments that are performed simultaneously on the substrate.

In one embodiment, a method of forming a pattern on a nitrocellulose film on a substrate is provided comprising: providing a nitrocellulose based film of uniform porosity on a substrate; defining a desired pattern on the substrate wherein at least one region of intended lower porosity is defined and wherein at least one region of intended normal porosity is defined; exposing to a flow of a suitable solvent vapor over the region of intended lower porosity wherein the nitrocellulose based film of the region of intended lower porosity is dissolved by the suitable solvent vapor; removing the suitable solvent vapor and the nitrocellulose based film from the region of intended lower porosity wherein the resulted lower porosity region is capable of separating “multiple experiments” that are performed simultaneously over the region of resulted normal porosity.

In one embodiment the suitable solvent vapor is acetone solvent vapor. In one other embodiment exposing the solvent vapor over the region of intended lower porosity is controlled by a robot in a programmable manner. In another embodiment exposing the solvent vapor over the region of intended lower porosity is achieved by delivering the solvent vapor through a flat hypodermic needle.

In one embodiment it further comprises using a shroud to wrap around the needle. In one embodiment it further comprises providing a vacuum to the shroud wherein the vacuum would prevent the solvent vapor from flowing into undesired regions. In one embodiment the vacuum is supplied at a flow rate of 27 normal liters per minute.

In one embodiment the solvent vapor is supplied to the needle generated by bubbling gas through a solvent bottle. In one embodiment the solvent bottle is held at a constant temperature. In one embodiment the bubbling gas is nitrogen air. In one embodiment the nitrogen is bubbled through at pressure of 1.5 psi and at a flow rate of 3.2 normal liters per minute.

In one embodiment the area the region of intended lower porosity can be controlled by altering the speed of the robot. In one embodiment the area the region of intended lower porosity can be controlled by altering the height of the robot over the substrate. In one embodiment the suitable solvent vapor is selected from the group consisting of: acetone, methyl acetate, methyl ether ketone, amyl acetate, chloroform, methylene chloride, ethylacetate, methyl formate, and methyl glycol acetate.

In one embodiment the nitrocellulose film is composed of nitrocellulose and cellulose or polymers. In one embodiment the substrate's temperature is controlled.

In another aspect of the invention, a nitrocellulose film on a substrate with pattern of lower porosity region and high porosity region made by a method comprising: providing a nitrocellulose based film of uniform porosity on a substrate; defining a desired pattern on the substrate wherein at least one region of intended lower porosity is defined and wherein at least one region of intended normal porosity is defined; exposing to a flow of a suitable solvent vapor over the region of intended lower porosity wherein the nitrocellulose based film of the region of intended lower porosity is dissolved by the suitable solvent vapor; removing the suitable solvent vapor and the nitrocellulose based film from the region of intended lower porosity wherein the resulted lower porosity is capable of separating “multiple experiments” that are performed simultaneously over the region of resulted normal porosity.

In one other aspect of the invention, an apparatus for patterning nitrocellulose slide on a substrate wherein the apparatus comprises at least one xyz robot wherein the xyz robot is further comprised of a plurality of pattering heads; at least one solvent bottle for each the pattering head wherein solvent vapor delivery is achieved through bubbling “nitrogen” through the solvent bottle; at least one liquid trap to trap any solvent backflow; at least one nitrocellulose slide on a substrate for patterning; at least one vacuum pump wherein the vacuum pump is used to secure the substrate by suctioning the substrate wherein the vacuum pump is further used to prevent overflow of the solvent vapor into unwanted region; at least one primary electrical solenoid valve to control the solvent vapor; at least one secondary electrical solenoid valve to control the substrate vacuum.

In one embodiment the solvent bottle is maintained at a constant temperature using a warm water bath. In one embodiment it is further comprised of a low-flow regulator used to control gas input pressure at a consistent stable level. In one embodiment it is further comprised of a cold water bath used to cool the substrate to a stable temperature above the dew point.

### BRIEF DESCRIPTION OF THE DRAWINGS

FIG. 1—A drawing of a patterning head with a needle and a vacuum shroud.

FIG. 2—A drawing a simple system to pattern a nitrocellulose surface using a patterning head mounted on an XYZ robot and solvent delivery by bubbling a gas through a liquid solvent.

FIG. 3—A photograph of a patterned nitrocellulose slide showing patterned regions of low-porosity, transparent nitrocellulose and un-patterned regions of higher porosity, semi-transparent nitrocellulose.

FIG. 4—A photograph of a patterned nitrocellulose slide showing patterned regions of low-porosity, transparent nitrocellulose and un-patterned regions of high porosity, white nitrocellulose.

FIG. 5—A photograph of a patterned nitrocellulose slide showing patterned regions of low-porosity, transparent nitrocellulose and un-patterned circular regions of high porosity, white nitrocellulose.

FIG. 6—Scanning Electron Micrograph (SEM) images showing original un-patterned, high-porosity, white nitrocellulose at 8000× magnification (A) and 1500× magnification (B). Patterned, low porosity, transparent nitrocellulose is shown at 8000× magnification (C) for comparison. The transition region between low-porosity and high-porosity nitrocellulose is shown at 1500× magnification in (D) where the far right of (D) is similar to (B).

FIG. 7—A schematic drawing of a 4 channel patterning head system with independent flow-rate control, temperature stabilized solvent bottles, and temperature controlled substrate platen. Substrates are secured by vacuum to prevent movement.

FIG. 8—Photograph of one embodiment of the 4 channel patterning system.

### DETAILED DESCRIPTION OF EMBODIMENTS

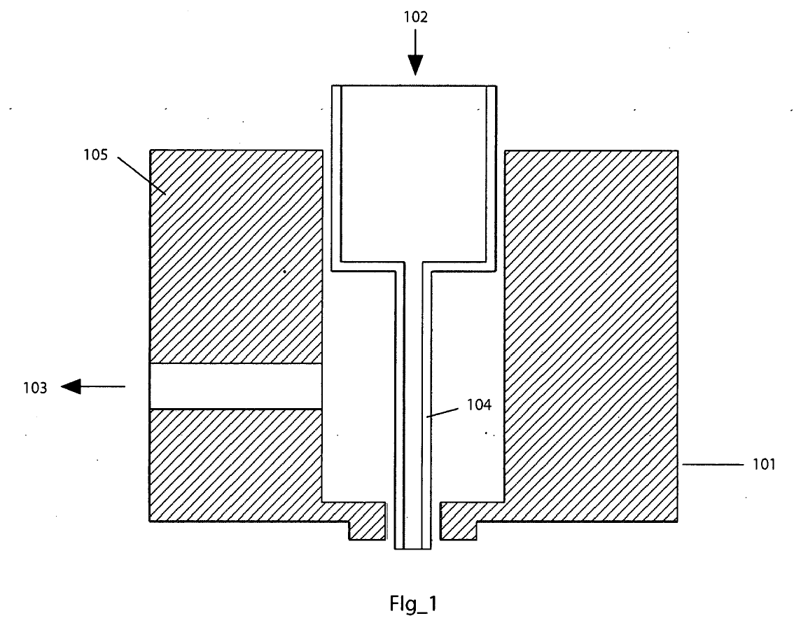

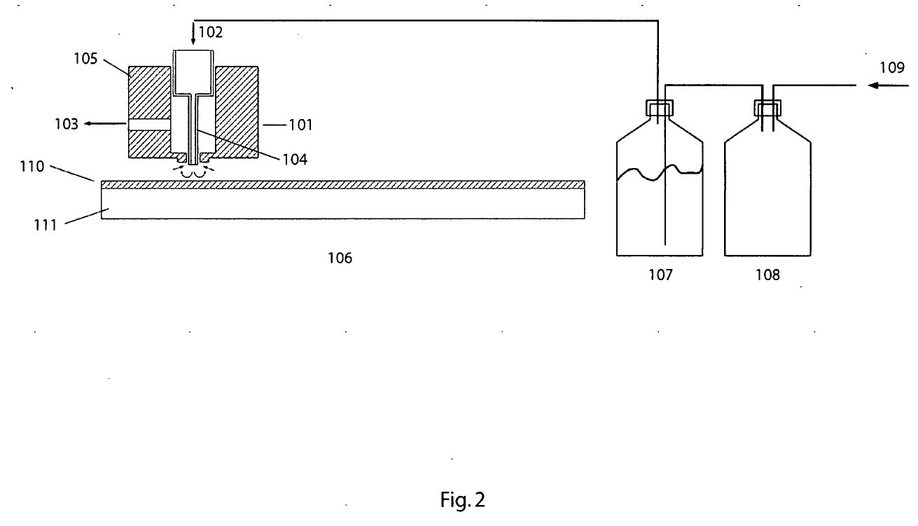

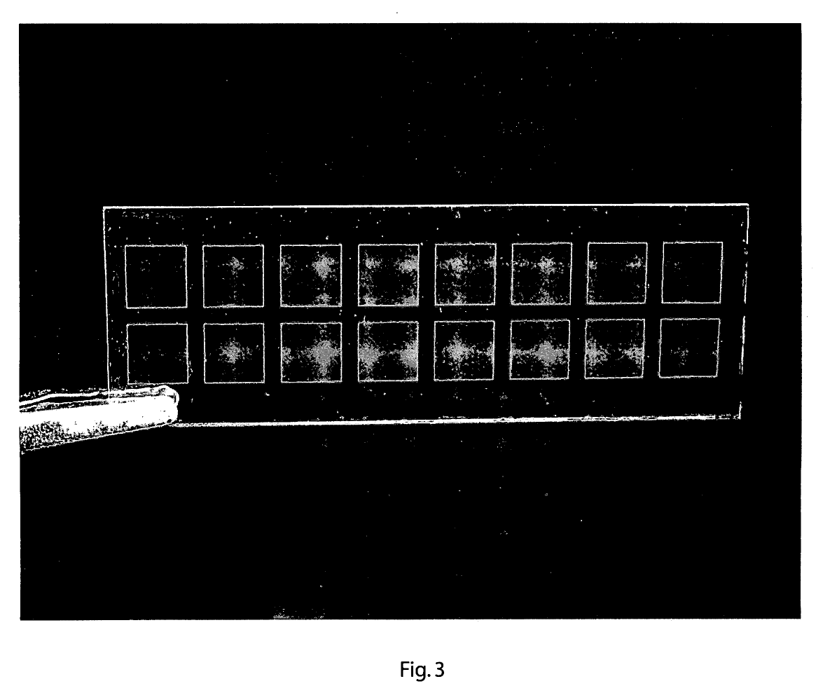

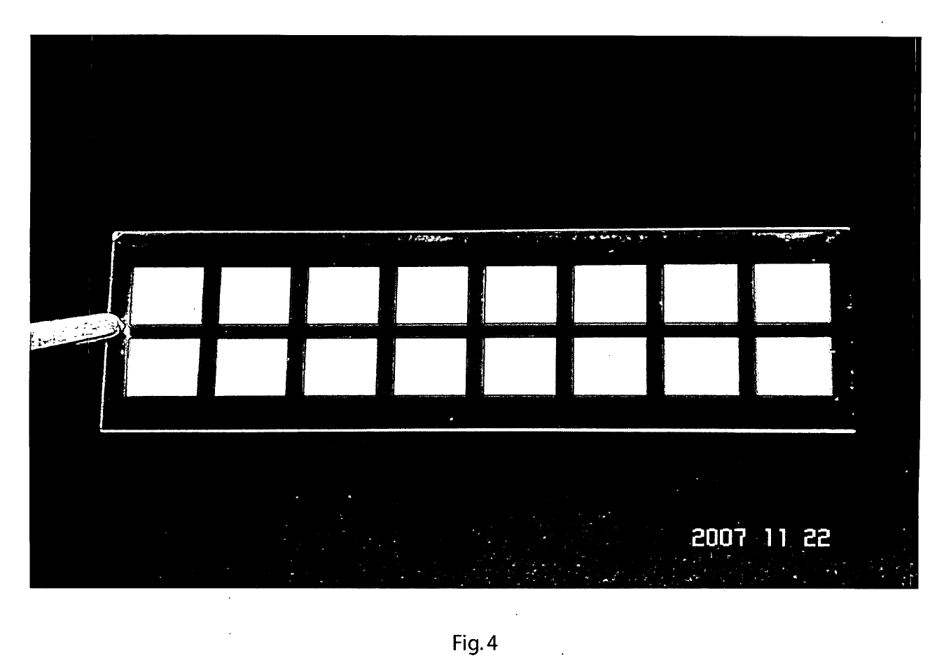

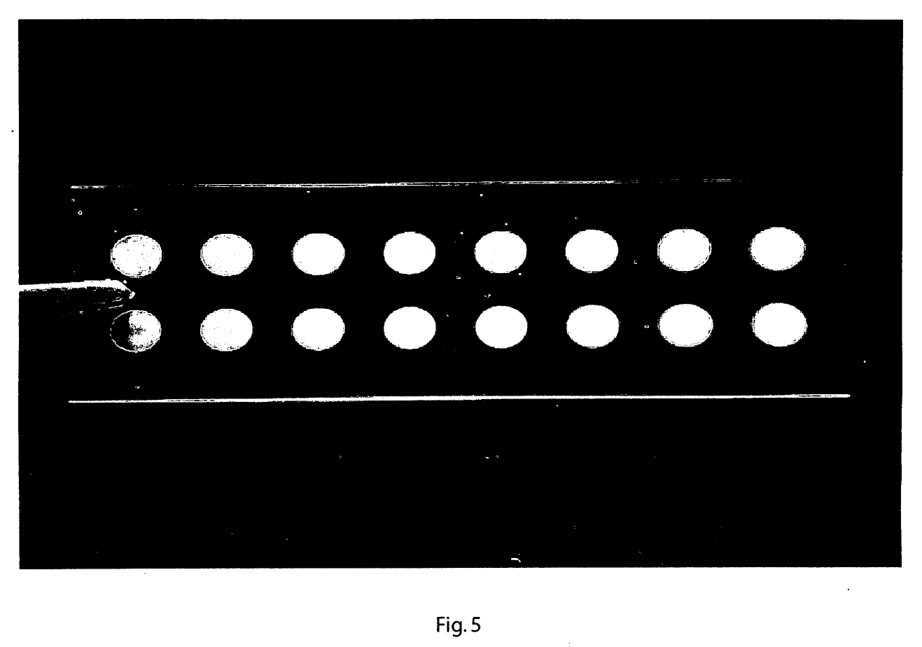

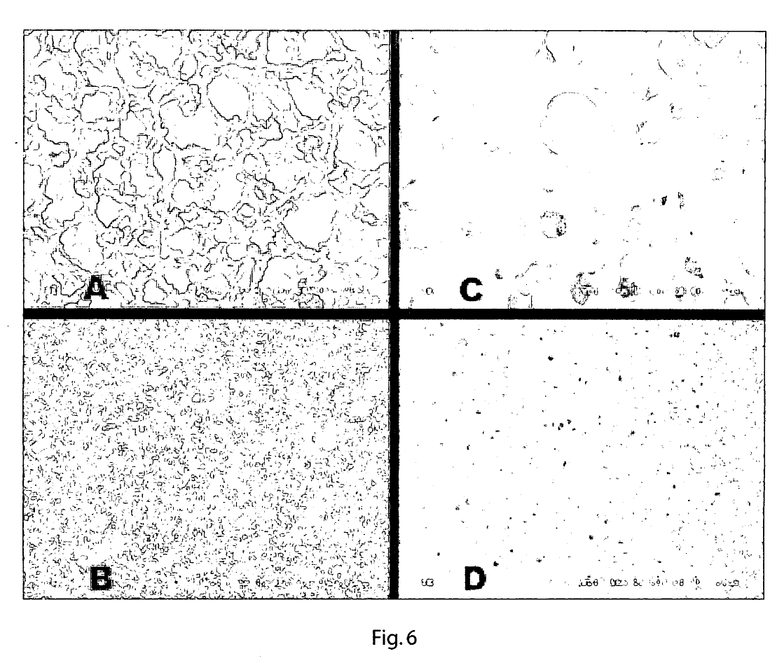

The present invention relates to the production of defined regions of differing porosity of a nitrocellulose(NC)-based film on a substrate. Starting with a substrate which has a nitrocellulose-based film of uniform porosity, areas of the film are exposed to a flow of a suitable solvent vapor such that the film in the exposed areas are dissolved in the solvent vapor and upon removal of the solvent vapor will dry as a film of lower porosity than the original film. The lower porosity region is then sufficient to separate (usually using a frame with a rubber seal) multiple experiments that are performed simultaneously on the substrate. In order to achieve sharp definition between regions a patterning head as shown in FIG. 1 is used. Solvent vapor is delivered through a needle in the center of the head. Vacuum is then supplied to the shroud around the needle to prevent solvent vapor from flowing into undesired regions. When mounting this head on a robot (FIG. 2), regions can be programmatically defined. Solvent vapor can be supplied to the head by bubbling a gas (such as nitrogen or air) through a solvent bottle. FIGS. 3, 4 & 5 show nitrocellulose slides that have been defined using the method of this invention. Acetone was used as the source of the solvent vapor and nitrogen was bubbled through at a pressure of 1.5 psi and a flow rate of 3.2 normal liters per minute (air). Vacuum was supplied at a flow rate of 27 normal liters per minute (air). Likewise, vacuum can be supplied at a flow rate of 10-30 normal liters per minute air. The height from the substrate to the solvent delivery needle was 0.55 mm and the XY speed was 10 m/s. FIGS. 3 and 4 show 7 mm square regions at a 9 mm pitch and FIG. 5 shows 7 mm circular regions at a 9 mm pitch. Line widths were 2 mm wide based on the flow rates, robot speed, and needle height. Other line widths are possible by varying these parameters. FIG. 6 shows scanning electron micrograph (SEM) images of the original, high porosity, nitrocellulose and low porosity regions of nitrocellulose produced using the method of this invention. The original, high porosity, white nitrocellulose film at 8000× magnification (FIG. 6A) was modified to the low-porosity, transparent nitrocellulose of FIG. 6C. The transition region is shown in FIG. 6D where the high porosity on the right is similar to FIG. 6B. The width of the transition region is less than 0.1 mm.

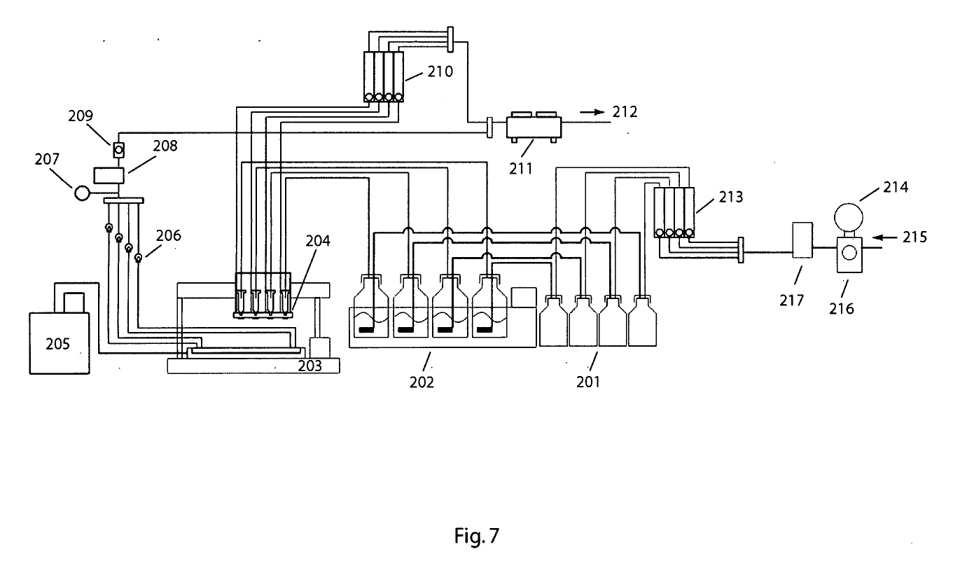

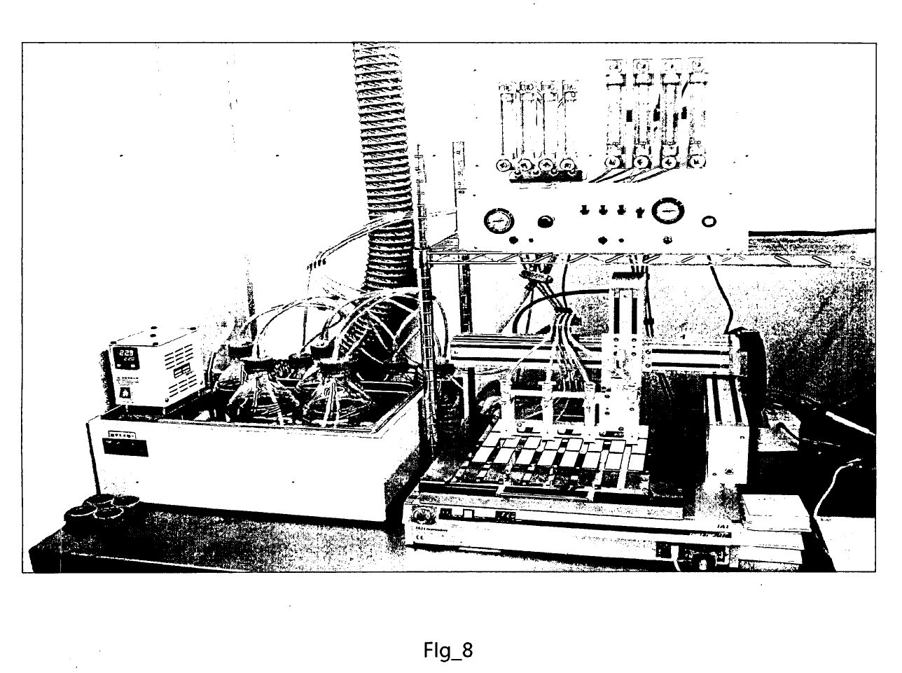

FIG. 7 shows a schematic of a system capable of processing 4 substrates simultaneously. The system has 4 patterning heads as in FIG. 1 mounted on a cantilever type xyz robot. Substrates are cooled using a cold water bath and solvent bottles are maintained at constant temperature using a warm water bath. Each head has independent flow control for nitrogen and vacuum. Substrates are secured using vacuum. FIG. 8 shows a picture of the 4 channel system. Vacuum pump and cold water bath are not shown.

The invention should not necessarily be limited to only nitrocellulose film but could also apply to mixtures of nitrocellulose and other celluloses or polymers. An example of which might be nitrocellulose mixed with cellulose acetate which is also a common substrate for protein assays.

### DETAILED DESCRIPTION OF THE FIGURES

In FIG. 1, a drawing of a patterning head 101 with a needle 104 and a vacuum shroud 105 is disclosed. Here, the solvent vapor 102 is supplied through the needle 104 to the substrate surface and excess vapor is removed from around the needle using a vacuum 103.

In FIG. 2, a simple patterning system 106 to pattern a nitrocellulose surface using a patterning head mounted on an XYZ robot and solvent delivery by bubbling a gas through a liquid solvent is disclosed. Here, regulated nitrogen N2 or air 109 is bubble through the solvent bottle 107 with the trap 108 designed to trap any unexpected solvent backflow. As solvent vapor 102 enters the patterning head 101 through needle 104, the shroud 105 keeps the solvent vapor 102 from escaping into unwanted region. Vacuum 103 is used in connection with the shroud 105 to remove any additional vapor from escaping into unwanted region. Also disclosed is the nitrocellulose film 104 on the substrate 105.

In FIG. 3, a photograph of a patterned nitrocellulose slide showing patterned regions of low-porosity, transparent nitrocellulose and un-patterned regions of higher porosity, semi-transparent nitrocellulose is disclosed. Here, the un-patterned regions are approximately 7 mm square at a 9 mm pitch.

In FIG. 4, a photograph of a patterned nitrocellulose slide showing patterned regions of low-porosity, transparent nitrocellulose and un-patterned regions of high porosity, white nitrocellulose is disclosed. Here, un-patterned regions are approximately 7 mm square at a 9 mm pitch.

In FIG. 5, a photograph of a patterned nitrocellulose slide showing patterned regions of low-porosity, transparent nitrocellulose and un-patterned circular regions of high porosity, white nitrocellulose is disclosed. Here, un-patterned regions are approximately 7 mm diameter circles at a 9 mm pitch.

In FIG. 6, a Scanning Electron Micrograph (SEM) images showing original un-patterned, high-porosity, white nitrocellulose at 8000× magnification (A) and 1500× magnification (B) is disclosed. Here, patterned, low porosity, transparent nitrocellulose is shown at 8000× magnification (C) for comparison. The transition region between low-porosity and high-porosity nitrocellulose is shown at 1500× magnification in (D) where the far right of (D) is similar to (B). The transition region is less than 100 micrometers.

In FIG. 7, a schematic drawing of a 4 channel patterning head system with independent flow-rate control, temperature stabilized solvent bottles, and temperature controlled substrate platen is disclosed. FIG. 7 shows a slide patterning system capable of patterning 4 slides at one time and 32 total slides in one run. Four patterning heads 204 are simultaneously mounted on an XYZ robot 203. Each head has independent solvent vapor delivery that is achieved by bubbling Nitrogen or Air 215 through a solvent bottle 202. Each solvent bottle has a liquid trap 201 on the gas input side to trap any unexpected solvent backflow. The flow rate of the solvent vapor is independently controlled for each head by a 1-5 l/min flow meter and valve 213 located between the gas inlet and the liquid trap. Additionally, each head has a vacuum connection with independent flow control using a 20-80 l/min flowmeter 210 and valve. Vacuum for the entire system is supplied using an oil-less rotory-vane (or equivalent) vacuum pump 211. Substrates are secured using the vacuum pump as well. The substrate platen is separated into 4 regions with independent vacuum control by manual cutoff valves 206 to allow for less-than-full-capacity use of the system. Electrical solenoid valve one 217 is provided for automatic control the solvent vapor (4 heads at once) and while Electrical solenoid valve two 208 is provided for the substrate vacuum by the XYZ robot. Solvent bottles 202 are maintained at a constant temperature (typically near room temperature) using a warm water bath. As solvent evaporates, the bottles tend to cool down. If allowed to cool the concentration of the solvent vapor will decrease dramatically. A low-flow regulator 216 is used to control gas input pressure at a consistent, stable level. The substrate platen is cooled to a stable temperature above the dew point using a cold water bath 205. Reducing the temperature of the substrates improves the effectiveness of the solvent vapor to reduce the porosity of the nitrocellulose films.

In FIG. 8, a photograph of on embodiment of a 4 channel patterning system is disclosed. Here, the vacuum pump and cold water bath (substrate temperature control) are not shown.

1. A method of forming a pattern on a nitrocellulose film on a substrate comprising:
a. providing a nitrocellulose based film of uniform porosity on a substrate;
b. defining a desired pattern on said nitrocellulose based film on said substrate wherein at least one region of intended lower porosity is determined and wherein at least one region of intended normal porosity is determined;
c. exposing to a flow of a suitable solvent vapor over said region of intended lower porosity wherein said nitrocellulose based film of said region of intended lower porosity is dissolved by said suitable solvent vapor;
d. removing said suitable solvent vapor and said nitrocellulose based film from said region of intended lower porosity.

2. The method of claim 1 wherein said suitable solvent vapor is acetone solvent vapor.

3. The method of claim 1 wherein exposing said solvent vapor over said region of intended lower porosity is controlled by a xyz robot in a programmable manner.

4. The method of claim 1 wherein exposing said solvent vapor over said region of lower porosity is achieved by delivering said solvent vapor through a flat hypodermic needle.

5. The method of claim 4 further comprising using a shroud to wrap around said needle.

6. The method of claim 5 further comprising providing a vacuum to said shroud wherein said vacuum would prevent said solvent vapor from flowing into said region of intended normal porosity.

7. The method of claim 6 wherein said vacuum is supplied at a flow rate of 10-30 normal liters per minute.

8. The method of claim 6 wherein said vacuum is supplied at a flow rate of 27 normal liters per minute.

9. The method of claim 1 wherein said solvent vapor is supplied to said needle generated by bubbling gas through a solvent bottle.

10. The method of claim 9 wherein said solvent bottle is held at a constant temperature.

11. The method of claim 9 wherein said bubbling gas is nitrogen air

12. The method of claim 9 wherein said nitrogen was bubbled through at pressure of 0.5-3 psi and at a flow rate of 0.5-5 normal liters per minute.

13. The method of claim 9 wherein said nitrogen was bubbled through at pressure of 1.5 psi and at a flow rate of 3.2 normal liters per minute.

14. The method of claim 3 wherein the area said region of intended lower porosity can be controlled by altering the speed of said xyz robot.

15. The method of claim 3 wherein the area said region of intended lower porosity can be controlled by altering the height of said xyz robot.

16. The method of claim 3 wherein the area said region of intended lower porosity can be controlled by altering the flow rates of solvent vapor and vacuum.

17. The method of claim 1 wherein said suitable solvent vapor is selected from the group consisting of: acetone, methyl acetate, methyl ether ketone, amyl acetate, chloroform, methylene chloride, ethylacetate , methyl formate, and methyl glycol acetate.

18. The method of claim 1 wherein said nitrocellulose film is composed of nitrocellulose and cellulose or polymers.

19. The method of claim 1 wherein said substrate's temperature is controlled.

20. A nitrocellulose film on a substrate with pattern of lower porosity region and high porosity region made by a method comprising:
a. providing a nitrocellulose based film of uniform porosity on a substrate;
b. defining a desired pattern on said substrate wherein at least one region of intended lower porosity is defined and wherein at least one region of intended normal porosity is defined;
c. exposing to a flow of a suitable solvent vapor over said region of intended lower porosity wherein said nitrocellulose based film of said region of intended lower porosity is dissolved by said suitable solvent vapor;
d. removing said suitable solvent vapor and said nitrocellulose based film from said region of intended lower porosity wherein said region of intended lower porosity becomes a region of resulted lower porosity wherein said region of intended normal porosity becomes a region of resulted normal porosity;
e. wherein said resulted lower porosity region is capable of separating multiple experiments that are performed simultaneously over said resulted region of normal porosity.

21. An apparatus for patterning nitrocellulose slide on a substrate wherein said apparatus comprises:
a. at least one xyz robot wherein said xyz robot is further comprised of a plurality of pattering heads;
b. at least one solvent bottle for each said pattering head wherein solvent vapor delivery is achieved through bubbling air through said solvent bottle;
c. at least one liquid trap to trap any solvent backflow;
d. at least one nitrocellulose slide on a substrate for patterning;
e. at least one vacuum pump wherein said vacuum pump is used to secure said substrate by suctioning said substrate wherein said vacuum pump is further used to prevent overflow of said solvent vapor into unwanted region;
f. at least one primary electrical solenoid valve to control the solvent vapor;
g. at least one secondary electrical solenoid valve to control the substrate vacuum.

22. The apparatus claim of 21 wherein said solvent bottle is maintained at a constant temperature using a warm water bath.

23. The apparatus claim of 21 further comprises a low-flow regulator used to control gas input pressure at a consistent stable level.

24. The apparatus claim of 21 further comprises a cold water bath used to cool said substrate to a stable temperature above the dew point.
